(19) United States
(12) Patent Application Publication
(10) Pub. No.: US 2013/0257856 A1
(43) Pub. Date: Oct. 3, 2013

(54) Determining a View of an Object in a Three-Dimensional Image Viewer

(71) Applicants: Ryan Hickman, Mountain View, CA (US); Thor Lewis, Mountain View, CA (US)

(72) Inventors: Ryan Hickman, Mountain View, CA (US); Thor Lewis, Mountain View, CA (US)

(73) Assignee: GOOGLE INC., Mountain View, CA (US)

(21) Appl. No.: 13/617,459

(22) Filed: Sep. 14, 2012

Related U.S. Application Data
(60) Provisional application No. 61/619,464, filed on Apr. 3, 2012.

(51) Int. Cl. G06T 15/00

(52) U.S. Cl. 345/419

(57) ABSTRACT

Methods and systems for determining a view of an object in a three-dimensional (3D) image viewer are described. In an example, a computing device may be configured to receive a 3D object data model that may have a default view for rendering an image depicting an object in a default position. The computing device may be configured to determine, by way of a simulation of movement of the object, a rest position of the object that may describe one or more of a size, an orientation, and a shape that the object maintains when subjected to one or more forces. The computing device may be configured to provide information associated with instructions for rendering in a 3D image viewer a given image representing the 3D object data model of the object, where the given image may depict the object in the determined rest position.

### CROSS REFERENCE TO RELATED APPLICATION

The present application claims priority to U.S. Provisional patent application Ser. No. 61/619,464, filed on Apr. 3, 2012, and entitled “Determining a View of an Object in a Three-Dimensional Image Viewer,” which is herein incorporated by reference as if fully set forth in this description.

### BACKGROUND

In computer graphics, three-dimensional (3D) modeling involves generation of a representation of a 3D surface of an object. The representation may be referred to as a 3D object data model, and can be rendered or displayed as a two-dimensional image via 3D rendering or displayed as an image. 3D object data models represent a 3D object using a collection of points in 3D space, connected by various geometric entities such as triangles, lines, curved surfaces, etc. Various techniques exist for generating 3D object data models utilizing point clouds and geometric shapes, for examples.

Being a collection of data, 3D models can be created by hand, algorithmically, or objects can be scanned, for example. As an example, an artist may manually generate a 3D image of an object that can be used as the 3D model. As another example, a given object may be scanned from a number of different angles, and the scanned images can be combined to generate the 3D image of the object. As still another example, an image of an object may be used to generate a point cloud that can be algorithmically processed to generate the 3D image.

3D object data models may include solid models that define a volume of the object, or may include shell or boundary models that represent a surface (e.g. the boundary) of the object. Because an appearance of an object depends largely on an exterior of the object, boundary representations are common in computer graphics.

3D models are used in a wide variety of fields, and may be displayed using a number of different types of interfaces. Example interfaces may provide functionality to enable interaction between a user and the 3D models.

### SUMMARY

The present application discloses systems and methods for determining a view of an object in a three-dimensional image viewer. In one aspect, a method is described. The method may comprise receiving, at a computing device, a three-dimensional (3D) object data model of an object. The 3D object data model may have a default view for rendering an image depicting the object in a default position. The method may also comprise determining, by way of a simulation of movement of the object, a rest position of the object. The rest position may describe one or more of a size, an orientation, and a shape that the object maintains when subjected to one or more forces including gravity. The method may also comprise providing information associated with instructions for rendering in a 3D image viewer a given image representing the 3D object data model of the object. The given image may depict the object in the determined rest position when the determined rest position differs from the default position.

In another aspect, a non-transitory computer readable medium having stored thereon instructions executable by a computing device to cause the computing device to perform functions is described. The functions may comprise receiving, at a computing device, a three-dimensional (3D) object data model of an object. The 3D object data model may have a default view for rendering an image depicting the object in a default position. The functions may also comprise determining, by way of a simulation of movement of the object, a rest position of the object. The rest position may describe one or more of a size, an orientation, and a shape that the object maintains when subjected to one or more forces including gravity. The functions may also comprise providing information associated with instructions for rendering in a 3D image viewer a given image representing the 3D object data model of the object. The given image may depict the object in the determined rest position when the determined rest position differs from the default position.

In still another aspect, a system is described. The system may comprise a computing device. The system may also comprise a memory, the memory storing instructions executable by the computing device to cause the computing device to receive a three-dimensional (3D) object data model of an object. The 3D object data model may have a default view for rendering an image depicting the object in a default position. The instructions also may be executable by the computing device to cause the computing device to determine, by way of a simulation of movement of the object, a given position of the object. The given position may describe one or more of a size, an orientation, and a shape that the object maintains when subjected to one or more forces including gravity. The instructions further may be executable by the computing device to cause the computing device to provide information associated with instructions for rendering in a 3D image viewer a given image representing the 3D object data model of the object. The given image may depict the object in the determined given position when the determined given position differs from the default position.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 illustrates an example system for object data modeling, in accordance with an embodiment.

FIG. 2 illustrates another example system for object data modeling, in accordance with an embodiment.

FIG. 3 illustrates a flowchart of an example method to determine a view of an object in a three-dimensional (3D) image viewer, in accordance with an embodiment.

FIG. 4A illustrates an example webpage layout, in accordance with an embodiment.

FIG. 4B illustrates an example 3D image viewer, in accordance with an embodiment.

FIG. 4C illustrates the example 3D image viewer with interactive options, in accordance with an embodiment.

FIG. 4D illustrates an object with multiple components in the example 3D image viewer with interactive options, in accordance with an embodiment.

FIG. 4E illustrates an example display of a shirt on a mannequin in the example 3D image viewer, in accordance with an embodiment.

FIG. 5 is a functional block diagram illustrating an example computing device used in a computing system that is arranged in accordance with at least some embodiments described herein.

FIG. 6 is a schematic illustrating a conceptual partial view of an example computer program product that includes a computer program for executing a computer process on a computing device, arranged according to at least some embodiments presented herein.

### DETAILED DESCRIPTION

The following detailed description describes various features and functions of the disclosed systems and methods with reference to the accompanying figures. In the figures, similar symbols identify similar components, unless context dictates otherwise. The illustrative system and method embodiments described herein are not meant to be limiting. It may be readily understood that certain aspects of the disclosed systems and methods can be arranged and combined in a wide variety of different configurations, all of which are contemplated herein.

In an example, a computing device may be configured to receive a three-dimensional (3D) object data model of an object. The 3D object data model may have a default view for rendering an image depicting the object in a default position in a 3D image viewer. The computing device may be configured to determine, by way of a simulation of movement of the object, a rest position of the object. The rest position may describe one or more of a size, an orientation, and a shape that the object maintains when subjected to one or more forces including gravity. The computing device may be configured to provide information associated with instructions for rendering in the 3D image viewer a given image representing the 3D object data model of the object. The given image may depict the object in the determined rest position when the determined rest position differs from the default position. In one example, the given image may depict the object in the default position when the determined rest position is substantially the same as the default position.

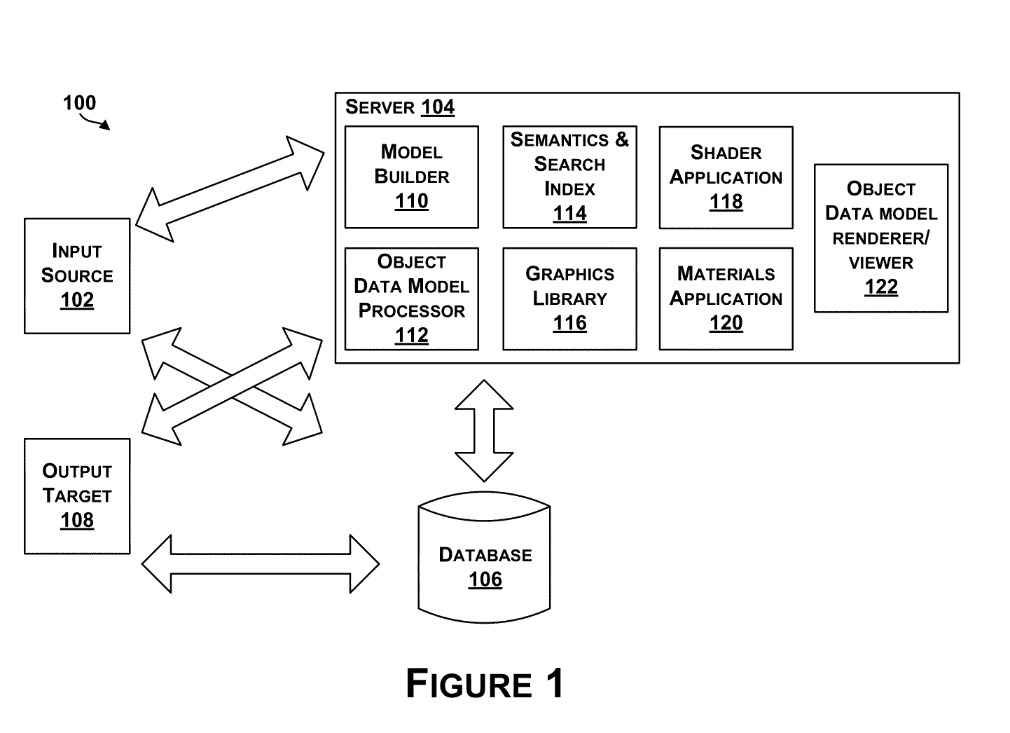

Referring now to the figures, FIG. 1 illustrates an example system 100 for object data modeling, in accordance with an embodiment. The system 100 includes an input source 102 coupled to a server 104 and a database 106. The server 104 is also shown coupled to the database 106 and an output target 108. The system 100 may include more or fewer components, and each of the input source 102, the server 104, the database 106, and the output target 108 may comprise multiple elements as well, or each of the input source 102, the server 104, the database 106, and the output target 108 may be interconnected as well. Thus, one or more of the described functions of the system 100 may be divided up into additional functional or physical components, or combined into fewer functional or physical components. In some further examples, additional functional and/or physical components may be added to the examples illustrated by FIG. 1.

Components of the system 100 may be coupled to or configured to be capable of communicating via a network (not shown), such as a local area network (LAN), wide area network (WAN), wireless network (Wi-Fi), or Internet, for example. In addition, any of the components of the system 100 may be coupled to each other using wired or wireless communications. For example, communication links between the input source 102 and the server 104 may include wired connections, such as a serial or parallel bus, or wireless links, such as Bluetooth, IEEE 802.11 (IEEE 802.11 may refer to IEEE 802.11-2007, IEEE 802.11n-2009, or any other IEEE 802.11 revision), or other wireless based communication links.

The input source 102 may be any source from which a 3D object data model may be received. In some examples, 3D model acquisition (shape and appearance) may be achieved by working with venders or manufacturers to scan objects in 3D. For instance, structured light scanners may capture images of an object and a shape of the object may be recovered using monochrome stereo cameras and a pattern projector. In other examples, a high-resolution DSLR camera may be used to capture images for color texture information. In still other examples, a raw computer-aided drafting (CAD) set of drawings may be received for each object. Thus, the input source 102 may provide a 3D object data model, in various forms, to the server 104. As one example, multiple scans of an object may be processed into a merged mesh and assets data model, and provided to the server 104 in that form.

The server 104 includes a model builder 110, an object data model processor 112, a semantics and search index 114, and a graphics library 116, a shader application 118, a materials application 120, and an object data model virtual renderer/viewer 122. Any of the components of the server 104 may be coupled to each other. In addition, any components of the server 104 may alternatively be a separate component coupled to the server 104. The server 104 may further include a processor and memory including instructions executable by the processor to perform functions of the components of the server 104, for example.

The model builder 110 receives the mesh data set for each object from the input source 102, which may include a data set defining a dense surface mesh geometry, and may generate an animated model of the object in 3D. For example, the model builder 110 may perform coherent texture unwrapping from the mesh surface, and determine textures of surfaces emulated from the geometry.

The object data model processor 112 may also receive the mesh data set for each object from the input source 102 and generate display meshes. For instance, the scanned mesh images may be decimated (e.g., from 5 million to 120,000 surfaces) utilizing texture-preserving decimation. Texture map generation can also be performed to determine color texture for map rendering. Texture map generation may include using the mesh data sets H that have colors but no UV (coordinate system of a 2D texture space) unwrapping to generate a mesh D with UV unwrapping but no colors. As an example, for a single output texture pixel of an image processing may include, for a given point in UV determine a triangle in the mesh's UV mapping D, and using triangle-local coordinates, move to an associated 3D point on the mesh. A bidirectional ray may be cast along the triangle's normal to intersect with the mesh H, and color, normal and displacement may be used for an output. To generate an entire texture image, each pixel in the image can be processed.

In some examples, the model builder 110 or the object data model processor 112 may output a 3D object data model of an object that includes one file with a combination of all data needed to render a 3D image of the object. In other examples, the model builder 110 or the object data model processor 112 may output a 3D object data model in the form of multiple files so that the 3D object data model file is divided into smaller parts.

The semantics and search index 114 may receive captured images or processed images that have been decimated and compressed, and may perform texture resampling and also shape-based indexing. For example, for each object, the semantics and search index 114 may index or label components of the images (e.g., per pixel) as having a certain texture, color, shape, geometry, attribute, etc. The semantics and search index 114 may receive the 3D object data model file or the files comprising the 3D object data model from the model builder 110 or the object data model processor 112, and may be configured to label portions of the file or each file individually with identifiers related to attributes of the file.

In some examples, the semantics and search index 114 may be configured to provide annotations for aspects of the 3D object data models. For instance, an annotation may be provided to label or index aspects of color, texture, shape, appearance, description, function, etc., of an aspect of a 3D object data model Annotations may be used to label any aspect of an image or 3D object data model, or to provide any type of information Annotations may be performed manually or automatically. In examples herein, an annotated template of an object in a given classification or category may be generated that includes annotations, and the template may be applied to all objects in the given classification or category to apply the annotations to all objects.

The graphics library 116 may include a WebGL or OpenGL mesh compression to reduce a mesh file size, for example. The graphics library 116 may provide the 3D object data model in a form for display on a browser, for example. In some examples, a 3D object data model viewer may be used to display images of the 3D objects data models. The 3D object data model viewer may be implemented using WebGL within a web browser, or OpenGL, for example.

The shader application 118 may be configured to apply a shader to portions of the 3D object data model file or to files of the 3D object data model according to the indexes of the file (as labeled by the semantics and search index 114) to generate a 3D image. The shader application 118 may be executed to apply a shader from a number of shaders according to the indexes of the file. The shader may include information related to texture, color, appearance, etc., of a portion of the 3D image.

In one example, the shader application 118 may be executed to render an image with shading attributes as defined by indexes of the files. For example, objects with multiple surfaces may have different attributes for each surface, and the shader application 118 may be executed to render each surface accordingly.

The materials application 120 may be configured to apply a material to portions of the 3D object data model file or to files of the 3D object data model according to the indexes of the file (as labeled by the semantics and search index 114) to generate a 3D image. The materials application 120 may be executed to apply a material from a number of materials according to the indexes of the file. The materials application may apply any material, such as leather, metal, wood, etc., so as to render an appearance of a portion of the 3D image.

In one example, the materials application 120 may access a database that includes information regarding a number of reference materials (e.g., brass, fur, leather), and objects with multiple materials may be separated into distinct portions so that the materials application 120 can be executed to render the separate distinct portions. As an example, a hood on a car may include a hood ornament, and the hood may be painted and the ornament may be chrome. The materials application 120 and the shader application 118 can be executed to identify two separate materials and render each material with an appropriate shade.

The object data model renderer/viewer 122 may receive the 3D object data model file or files and execute the shader application 118 and the materials application 120 to render a 3D image.

The database 106 may store all data sets for a 3D object data model in any number of various forms from raw data captured to processed data for display.

The output target 108 may include a number of different targets, such as a webpage on the Internet, a search engine, a database, etc. The output target 108 may include a 3D object data model viewer that enables product advertisements or product searches based on the 3D object data model.

In examples herein, the system 100 may be used to acquire data of an object, process the data to generate a 3D object data model, and render the 3D object data model for display.

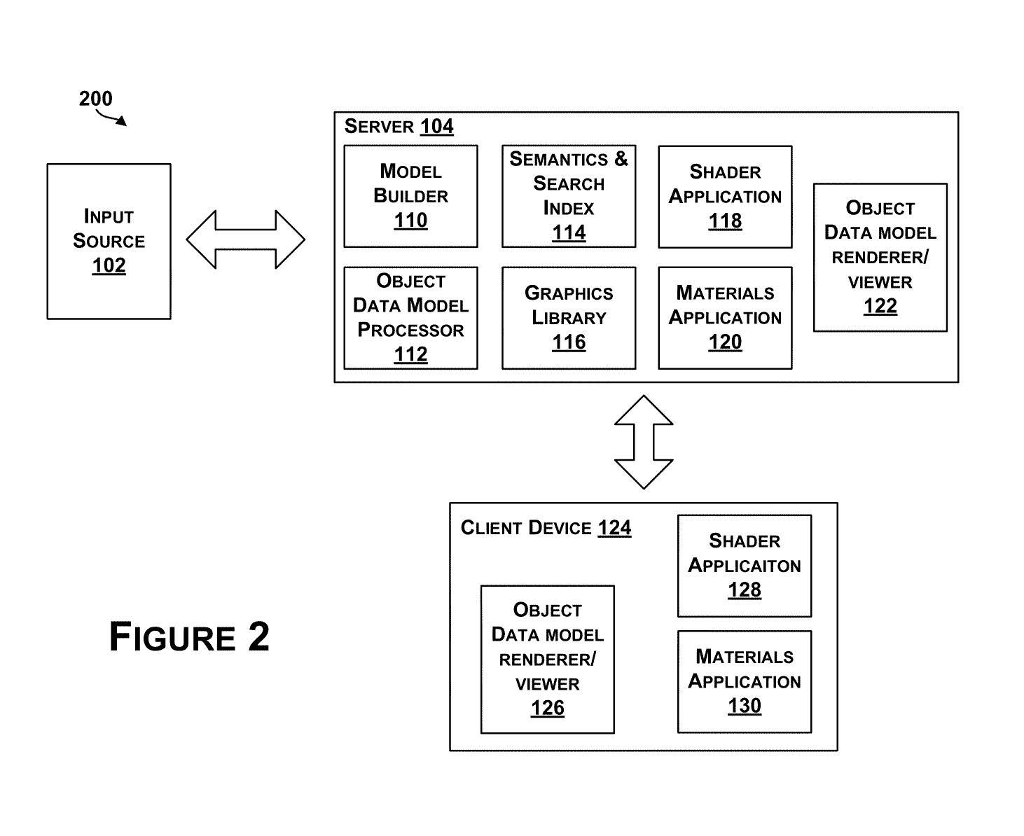

FIG. 2 illustrates another example system 200 for object data modeling, in accordance with an embodiment. The system 200 includes the input source 102 coupled to the server 104, which is coupled to a client device 124. The input source 102 and the server 104 may be as described in FIG. 1. The client device 124 may receive outputs from any of the components of the server 124, and may be configured to render a 3D image.

The client device 124 includes an object data model renderer/viewer 126, a shader application 128, and a materials application 130. The object data model renderer/viewer 126, the shader application 128, and the materials application 130 may all be configured as described with respect to the object data model renderer/viewer 122, the materials application 120, and the shader application 118 of the server 104 as described with respect to FIG. 1.

In some examples, the client device 124 may receive the 3D object data model file or files from the server 104 and render a 3D image of the object by executing the shader application 128 and the materials application 130. When executing the shader application 128 and the materials application 130, the client device 124 may access separate databases to retrieve appropriate shader and material information to apply to the image, access the server 104 to receive appropriate shader and material information from the shader application 118 and the materials application 120, or may store information locally regarding the appropriate shader and material information to apply.

In some examples, the client device 124 may receive the 3D object data model file or files from the server 104 and render a 3D image of the object. In other examples, the server 104 may render a 3D image of the object and stream the 3D image to the client device 124 for display.

As described, in some examples, the 3D object data model may include various forms of data, such as raw image data captured, mesh data, processed data, etc. Data of the 3D object data model may be encoded and compressed so as to store information related to 3D geometry of an object associated with information related to appearance of the object for transmission and display within a web browser or application on a device.

In one example, data of the 3D object data model may be compressed by initially encoding a triangle mesh representing the 3D object as a list including a plurality of vertices and a plurality of indices. Each vertex in the list may have several arbitrary parameters associated with the vertex, including, but not limited to, position, surface normal, and texture coordinates. The triangle indices may be stored in a 16-bit unsigned integer format and vertex attributes may be stored in a 32-bit floating point format. The 32-bit floating point format vertex attributes may be reduced to 15-bits. In instances in which compressed data is for a version of a web browser or application that does not have the ability to decompress dictionary encoded data, a delta compression may be used to store differences between the triangle indices and vertex attributes, either in an array of structures layout or a transposed layout. After delta compression, post-delta data may be ZigZag encoded (e.g., using open-source Protocol Buffer library available from Google Inc.). Encoding may follow the format ZigZag(x): (x<<1)̂ (x>>15) with a corresponding decoding (during decompression) to follow the format UnZigZag(x): (x>>1)̂(−(x & 1)). ZigZag encoding may be followed by multi-byte character encoding using UTF-8 encoding. Finally, the UTF-8 encoded data may be compressed using GNU Gzip or bzip2 to generate a compressed 3D object data model file.

The compressed copy of the 3D object data model file may be stored in a database, such as the database 106 in FIG. 1, in the server 104, or on the client device 124, for example. In some examples, the compressed 3D object data model file may be provided by the server 104 to the client device 124 in response to a request from the client device 124. If using a web browser to view the 3D object data model file, the client device 124 may decompress the compressed 3D object data model file according to Java instructions provided in the object browser web page. A local copy of the object browser web page and a local copy of the uncompressed, searchable data of the 3D object data model file can be stored in local memory of the client device 124. The client device 124 may display exemplary screenshots of an initial default view of a 3D object, based on the searchable data of the 3D object data model file loaded in the web browser.

In some examples, the 3D object data file includes information as to geometry of an object sorted by material and divided into portions to be loaded as fragments and reassembled in portions by the client device. As one example, for a mobile phone comprising multiple parts, each part may be rendered using a separate or distinct shader for each material. Thus, the 3D object data file may be divided into multiple portions and compressed as described above to retain all portions. The client device may receive the compressed 3D object data file, decompress the file, and reassemble the portions of the object one-by-one by loading each fragment of the file, streaming file requests for each shader, and reassembling an image of the object.

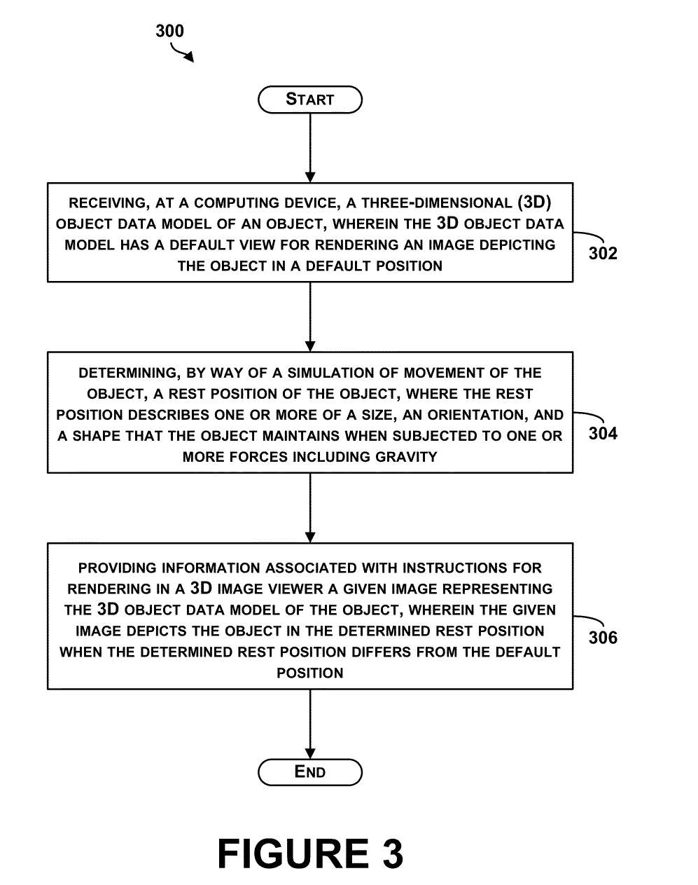

As described above, the systems 100 or 200 may be used to acquire data of an object, process the data to generate a 3D object data model, and render the 3D object data model for display. FIG. 3 illustrates a flowchart of an example method 300 to determine a view of an object in a 3D image viewer, in accordance with an embodiment. The method 300 shown in FIG. 3 presents an embodiment of a method that could be used by the systems 100 or 200 of FIGS. 1-2, for example.

The method 300 may include one or more operations, functions, or actions as illustrated by one or more of blocks 302-306. Although the blocks are illustrated in a sequential order, these blocks may in some instances be performed in parallel, and/or in a different order than those described herein. Also, the various blocks may be combined into fewer blocks, divided into additional blocks, and/or removed based upon the desired implementation

In addition, for the method 300 and other processes and methods disclosed herein, the flowchart shows functionality and operation of one possible implementation of present examples. In this regard, each block may represent a module, a segment, or a portion of program code, which includes one or more instructions executable by a processor for implementing specific logical functions or steps in the process. The program code may be stored on any type of computer readable medium or memory, for example, such as a storage device including a disk or hard drive. The computer readable medium may include a non-transitory computer readable medium or memory, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example.

In addition, for the method 300 and other processes and methods disclosed herein, each block in FIG. 3 may represent circuitry that is wired to perform the specific logical functions in the process.

At block 302, the method 300 includes receiving, at a computing device, a 3D object data model of an object, where the 3D object data model has a default view for rendering an image depicting the object in a default position. In examples, the computing device may be a server such as the server 104 in FIG. 1. In an example, the computing device may be configured to receive a 3D object data model file from another server. The 3D object data model file may include data to render an image depicting an object, or the 3D object data model file may be one of many files for the object (e.g., an object may be a mobile phone that has ten parts, and each part of the phone may be represented by a distinct file). The 3D object data model file may be an indexed file such that portions of image(s) represented by the file are labeled with a pointer to a shader or material that can be used to render an attribute of the object. As an example, for a mobile phone object, the mobile phone may have a rubber backing, a lens, a metal frame, etc., and each portion of the object may be represented by the file and indexed to an appropriate shader or material application.

The computing device may, thus, be configured to receive the 3D object data model file or files and execute the shader application and the materials application to render an image of the object. The 3D object data model, as received at the computing device, may have a default or an initial view of the object such that the image of the object may depict the object in a default position corresponding to the default view.

At block 304, the method 300 includes determining, by way of a simulation of movement of the object, a rest position of the object, where the rest position describes one or more of a size, an orientation, and a shape that the object maintains when subjected to one or more forces including gravity. The computing device may include a physics engine or module that may, for example, store physics rules of rigid body dynamics and soft body dynamics. The physics engine may be configured to run a simulation of movement the object and apply relevant physics rules (e.g., apply rigid body dynamics rules when the object is rigid, and apply soft body dynamics rules when the object is made of a soft material) to determine a rest position of the object when the object is subjected to one or more forces. In an example, the physics engine may be configured to simulate movement of the object subjected to gravity and accordingly determine a corresponding rest position of the object. The rest position may describe a size, an orientation, and/or a shape that the object may seek to maintain when subjected to gravitational force, for example.

The one or more forces may be dynamic (i.e., vary over time). In this case the rest position may change based on changes in the one or more forces. Thus, the rest position can be instantaneous depending on the forces that the object is subjected to at a particular instant, and may vary over time.

The physics engine may include a computer software that provides an approximate simulation of physical systems, such as rigid body dynamics, soft body dynamics, and fluid dynamics. In an example, the physics engine may be classified as either real-time or high-precision. A high-precision physics engine may require more processing power to calculate precise physics variables and may be used for computer animated simulations. A real-time physics engine may use simplified calculations, as compared to the high precision physics engine, and decreased accuracy.

In an example, an object may be represented by two separate meshes or shapes. One of the meshes may include a complex and detailed shape (e.g., vase with curved and looping handles). A second, simplified mesh may be used to represent the object to the physics engine so that the physics engine may be configured to treat the vase as a simple cylinder, for example. The simplified mesh used for physics simulation may be referred to as a collision geometry that may include a bounding box, sphere, or convex hull.

As an alternative to using bounding box-based rigid body physics systems simulation, the physics engine may be configured to use a finite element-based system. In such a system, a 3D volumetric tessellation may be created of the object. The tessellation may result in a number of finite elements which represent aspects of the object's physical properties such as toughness, plasticity, and volume preservation. Once constructed, the finite elements may be used by the physics engine to model forces acting on or within the object, for example. Visual representation of the object may be altered by the finite element system through use of a deformation shader simulated on the computing device executing software associated with the physics engine.

Physics-based animation may use rigid body dynamics because rigid body dynamics may be faster to simulate, but to accurately determine a rest position of the object, the physics engine may also use soft body dynamics. Soft body dynamics may be used to simulate liquids and cloth, for example.

In examples, the physics engine may be configured to simulate forces acting on a simulated object. As an example, the physics engine may be configured to use one or more of three methods to perform simulations: a penalty method, where interactions between objects or between an object and a surface are commonly modeled as mass-spring systems; a constraint based method, where constraint equations are solved that estimate physical laws; and an impulse based method, where impulses are applied to object interactions.

In some examples, the computing device including the physics engine may be configured to include a dedicated Physics Processing Unit (PPU) that may handle physics processing, similar to how a Graphic Processing Unit (GPU) performs graphics calculations.

As an example, the computing device may be configured to utilize a set of instructions from a Physics Abstraction Layer (PAL) library. The PAL library may provide a unified interface to a number of different physics engines. PAL may enable use of multiple physics engines within one application. Examples of the physics engines may include “Box2D”, “Bullet”, “Havok”, “IBDS”, “JigLib”, “Newton”, “ODE”, “OpenTissue”, “PhysX” (nVidia PhysX), “Simple Physics Engine”, “Tokamak”, and “TrueAxis.” Other examples and software packages are possible.

In an example, the computing device may be configured to determine the rest position of the object on a given surface with given physical properties such as rigidity. In an example, the computing device may be configured to simulate the object falling under the effect of gravity onto a rigid surface and accordingly determine a natural rest position of the object on the rigid surface. The rigid surface is used herein for illustration only, other surfaces are possible.

In an example, the 3D object data model may be characterized based on parameters defining rendering features of the image depicting the object. The parameters may include, for example, a material parameter characterizing a material of the object. In the example, the computing device may be configured to determine the rest position based on the material of the object. A rest position of a first object made of a soft material may be different from a respective rest position of a second object that may have the same size as the first object but is made of hard material, for example.

In some examples, the object may comprise multiple components and a respective material may be associated with each respective component of the multiple components. The computing device may be configured to take into account respective materials of the multiple components when determining the rest position of the object.

For example, to determine the rest position of the object, the computing device may be configured to determine a center of gravity of the object. The center of gravity of the object, and thus the rest position, may depend on the respective materials of the multiple components. For instance, the object may include a component made of aluminum and the computing device may accordingly determine the center of gravity and the rest position of the object. If a material of the component is changed to steel, for example, the center of gravity of the object may change and the determined rest position may accordingly change.

In an example, the object may include a given component with a predetermined proper (e.g., upright) orientation. For instance, the object may be a pen including a logo or a name of a manufacturer. The pen may have multiple rest positions when subjected to gravitational forces that may satisfy physics rules simulated by the physics engine, for example. However, orientation of the pen in a first rest position may show the logo or the name of the manufacturer upside down. A second rest position may show the logo or the name in a proper orientation (e.g., upright position). The computing device may be configured to determine the rest position such that the logo is depicted in the predetermined proper or upright orientation.

At block 306, the method 300 includes providing information associated with instructions for rendering in a 3D image viewer a given image representing the 3D object data model of the object, where the given image depicts the object in the determined rest position when the determined rest position differs from the default position. The computing device may be configured to launch or initiate a 3D image viewer for rendering a given image representing the 3D object data model. The given image may depict the object in the determined rest position when the determined rest position is different from the default position corresponding to the default or initial view of the 3D object data model as received at the computing device.

In an example, the 3D image viewer may be embedded within a webpage. The webpage, thus, may include executable instructions identifying the 3D image viewer to be embedded within the webpage. For example, the computing device may be configured to serve a rendered image and/or instructions for rendering an image using graphics software such as WebGL, OpenGL ES, etc., to the webpage. In one example, WebGL may be used to render the image within the 3D image viewer (that may be embedded in the webpage) based on the information received from the computing device (e.g., the server).

In some examples, the 3D image viewer may be embedded directly within the webpage with JavaScript or other scripting languages. For example, JavaScript may be used to render an iframe (or inline frame). In other examples, the 3D image viewer may be included within the webpage by pasting a block or section of HTML into code for the webpage. The block of HTML may describe information associated with parameters for customizing the display of the 3D image viewer.

The computing device may be configured to define parameters for customizing the 3D image viewer (e.g., size, background, user interface options, etc.) as well as parameters for customizing/controlling a rendering of the 3D object data model within the 3D image viewer (e.g., rest position, size, animation, camera angle, orientation, zoom level, color, texture, shading, overlays, etc.).

In one example, the computing device may be configured to launch or initiate the 3D image viewer in a window that pops-up from the webpage. In other examples, the 3D image viewer is not launched in a separate window, but may be initiated within the webpage. Other arrangements are possible.

In an example, a search engine may receive a search query by way of the webpage and the search engine, accordingly, may be configured to generate search results based on the search query and may also be configured to generate advertisements based on the search query. The advertisements may be associated with a product or a service being advertised.

The computing device may be configured to generate a display of the webpage, the search results, and the advertisement on a display device. The computing device may be configured to initiate the 3D image viewer by receiving a selection of an advertisement provided in the webpage.

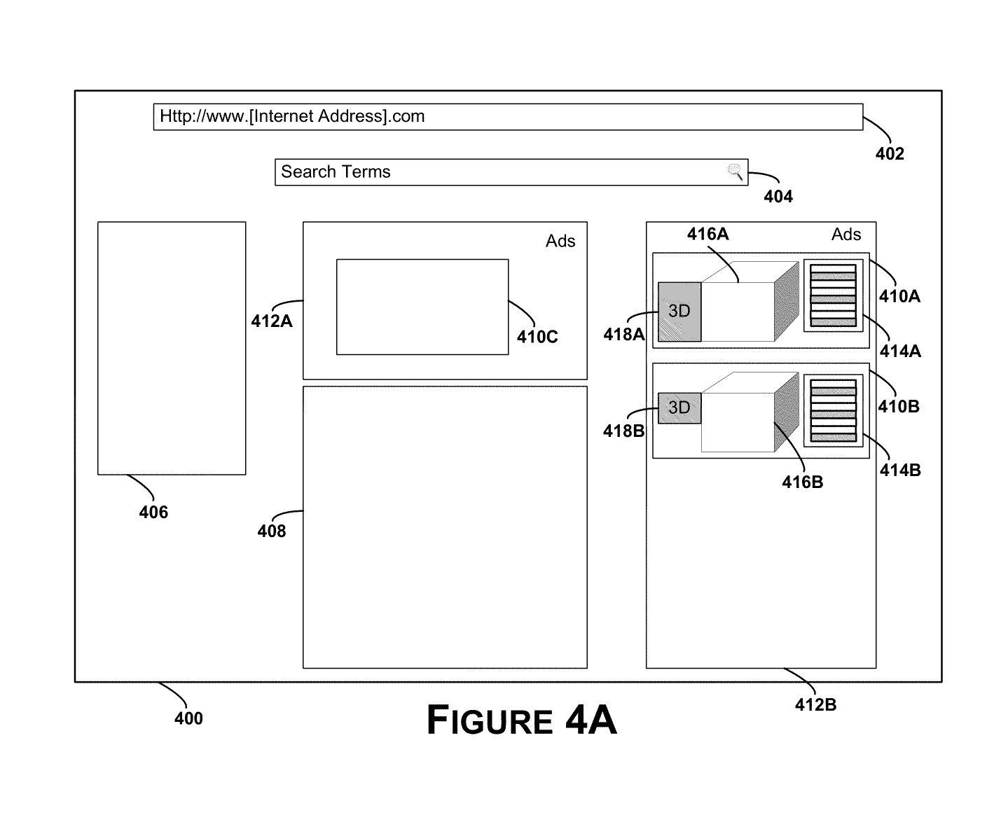

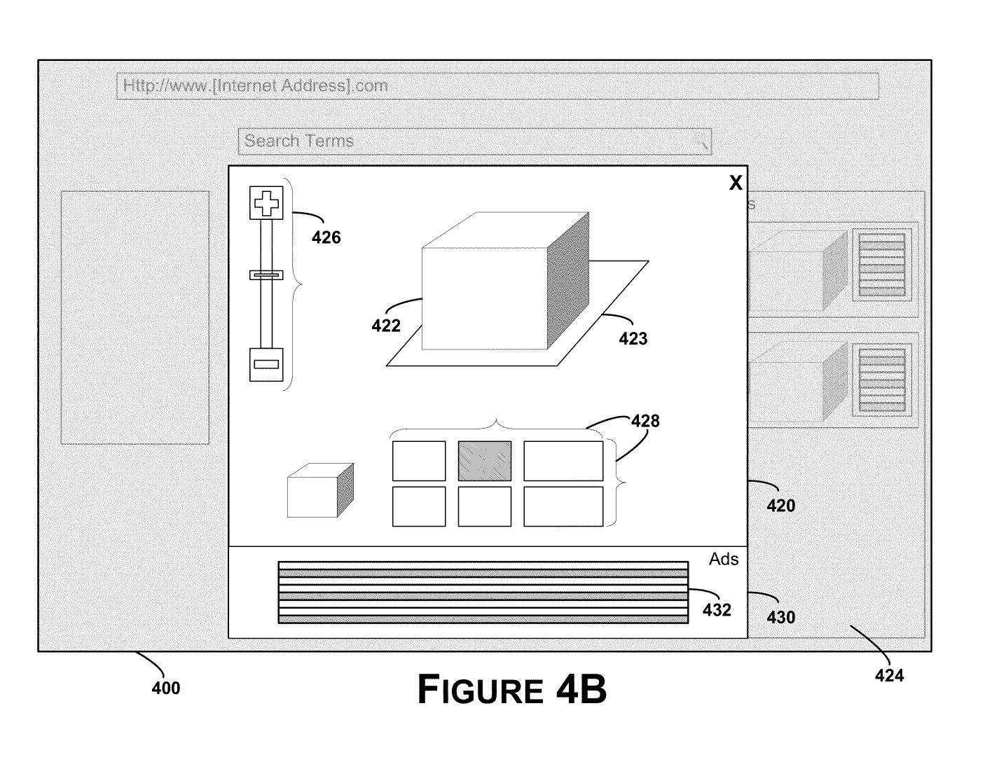

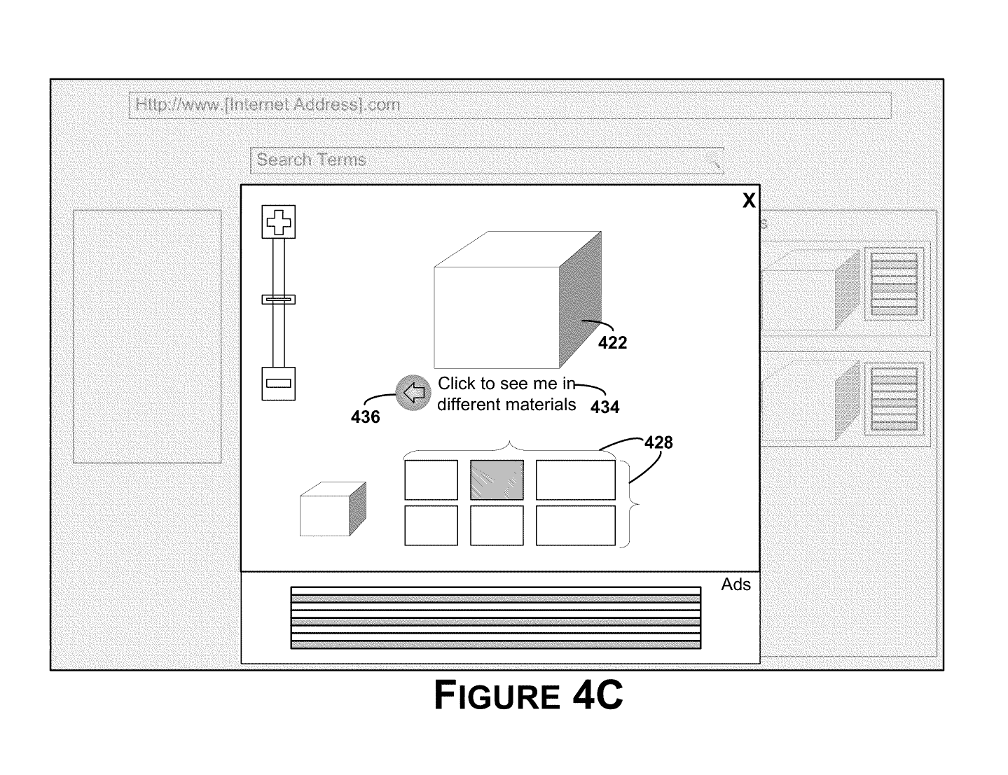

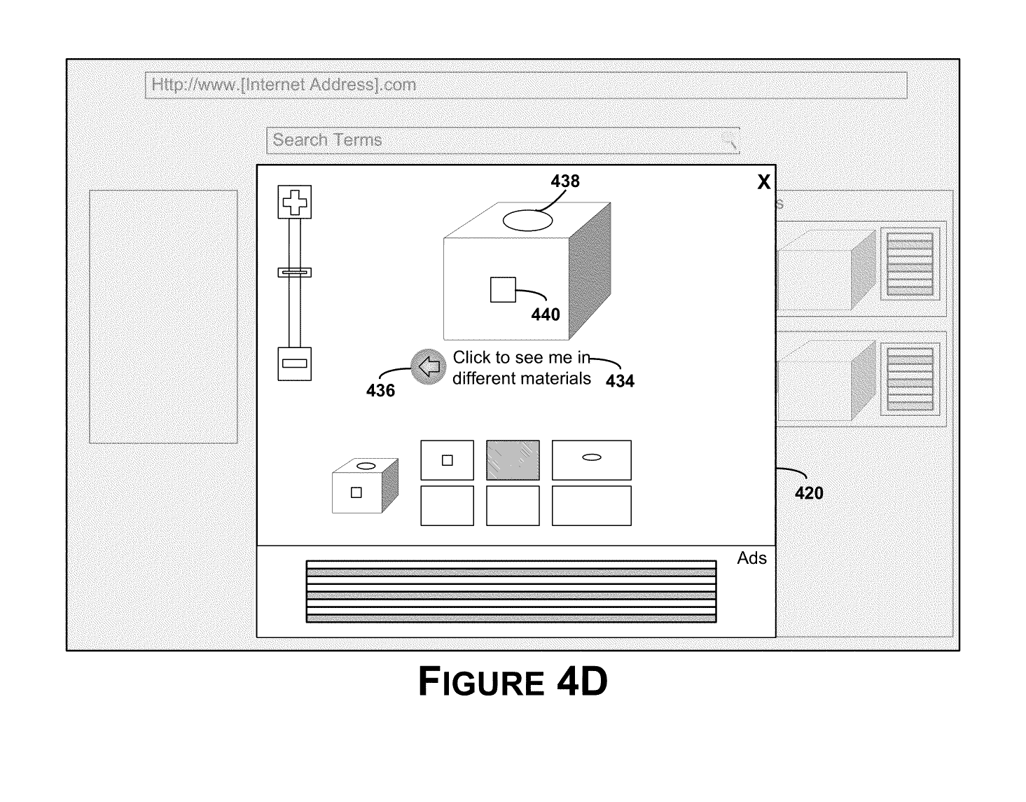

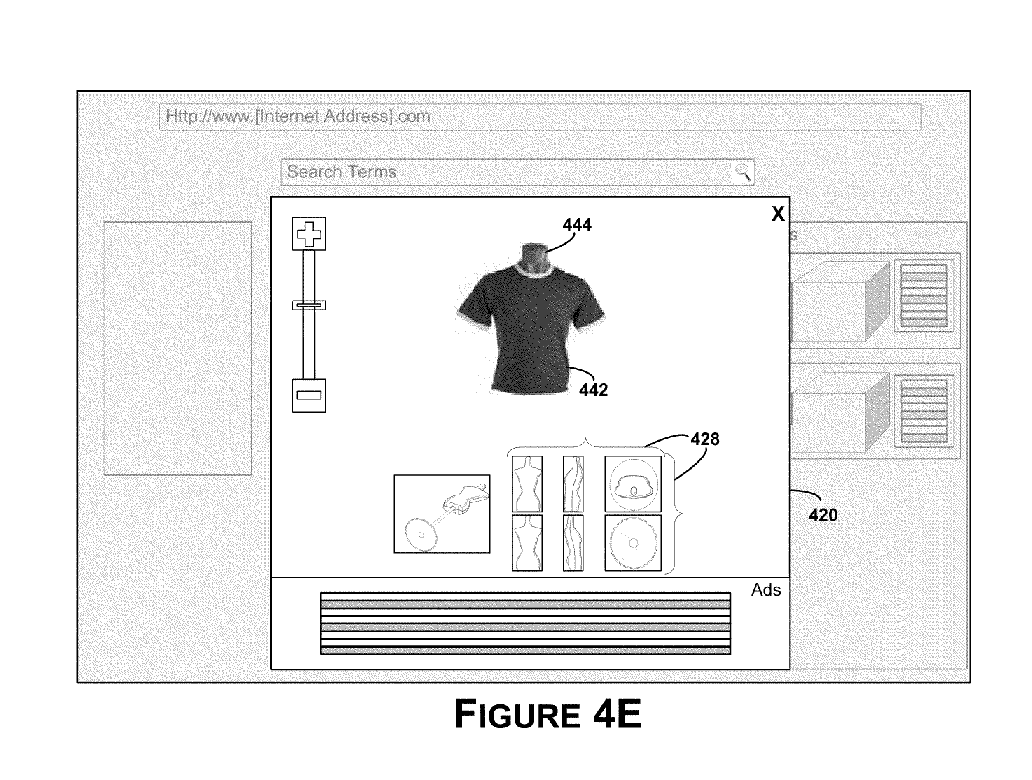

FIG. 4A illustrates an example webpage layout, in accordance with an embodiment. The webpage 400 may include an address bar 402 to receive an internet address of the search engine. The search engine may be configured to receive, through network communication (e.g., the internet) a search term or search query input by way of a search terms input box 404, for example. The webpage 400 may include miscellaneous information and search functionalities 406, for example. The search engine may be configured to conduct a search on the World Wide Web based on the search query input in the search terms input box 404, and accordingly the webpage 400 may be configured to display search results 408, and 2D advertisements 410A, 410B, and 410C in advertising areas 412A-B, for example. Two 2D advertisements 410A-B are shown in the advertising area 412B and one 2D advertisement is shown in the advertising area 412A for illustration only. More or less advertisements can be shown. Also, this webpage layout is for illustration only, and other layouts are possible.

The 2D advertisements 410A, 410B, and 410C displayed in the advertising areas 412A-B may be relevant to the search terms used to conduct the search. For example, if a search term used is a “shoe”, the 2D advertisements 410A, 410B, and 410C may be advertising shoes. The 2D advertisements 410A, 410B, and 410C may include text relating to an object being advertised and/or an image relating to or of the object being advertised. For example, the 2D advertisement 410A may include text 414A and image 416A of a respective object being advertised. Similarly, the 2D advertisement 410B may include text 414B and image 416B of another respective object being advertised.

In FIG. 4A, for example, rectangular boxes 418A-B labeled “3D” are attached to the images 416A-B and are user-selectable. The computing device may be configured to receive a request to initiate the 3D image viewer when a user clicks on the boxes 418A-B (e.g., by way of a mouse arrow or cursor), for example. In another example, the 2D advertisements 410A, 410B, and 410C may be selectable by the user clicking anywhere on the 2D advertisements 410A, 410B, and 410C. In other examples, hovering over a given area of the 2D advertisements 410A, 410B, and 410C with a mouse arrow or reticle may initiate the request. Other shapes and arrangements are possible to provide a mechanism for the computing device to receive the request.

FIG. 4B illustrates an example 3D image viewer 420, in accordance with an embodiment. In FIG. 4B, the 3D image viewer 420 is initiated in a separate window that pops-up from the webpage 400, for illustration only. The computing device may be configured to initiate the 3D image viewer 420 upon receiving the request by way of a click on the box 418A, for example. In this example, the 3D image viewer may be configured to display an image 422 representing a 3D object data model of the object being advertised in the 2D advertisement 410A. The computing device may be configured to render the image 422 such that the object is depicted in the determined rest position (e.g., determined by the method 300).

In an example, the computing device may be configured to determine the rest position of the object on a default surface (e.g., a rigid surface). In the example, the object may be depicted in the 3D image viewer 420 resting on the surface 423 that may be the default surface. In some examples, the computing device may be configured to give the user an option to change the surface, and in these examples, the computing device may be configured to simulate movement of the object by way of the physics-based simulation using physical properties of the changed surface.

In an example, the computing device may be configured to obscure contents of the webpage 400, excluding the pop-up window including the 3D image viewer 420, by providing a semi-transparent graphic 424 overlaid onto the contents of the webpage 400 as shown in FIG. 4B. Other display arrangements may be implemented as well to provide visual contrast between the 3D image viewer 420 and other content of the webpage 400. In other examples, the content of the webpage 400 may not be obscured and may not be visually contrasted to the 3D image viewer 420.

The 3D image viewer 420 may be configured to provide a zooming tool 426 such that a user may be able to zoom in or out to focus on features or components of the object displayed in the 3D image viewer 420. The 3D image viewer 420 also may be configured to provide a view change tool 428 that the user may be able to use to view different views (e.g., side views, top view, bottom view, etc.) of the object depicted in the image 422. Other tools, capabilities, and functionalities may be possible.

In an example, the computing device may be configured to receive a given request to change a view of the object in the 3D image viewer 420 by way of the view change tool 428 and may accordingly be configured to determine a respective rest position corresponding to the changed view. The computing device may be configured to generate a modified display, in the 3D image viewer 420, of the object in the respective rest position.

In another example, the rest position of the object may differ based on an orientation of the object. In this example, the computing device may be configured to receive (e.g., from a user) information associated with a preferred orientation of the object and determine a respective rest position corresponding to the preferred orientation. The computing device may further be configured to render the image (e.g., the image 422) to depict the object in the preferred rest position.

In still another example, the computing device may be configured to receive feedback from the user that is responsive to the rest position depicted in the 3D image viewer 420. The user may, for example, indicate acceptance or rejection of the determined rest position and may request changes to a preferred rest position. In an example, the computing device may be configured to modify the rest position, based on the feedback, to generate a view for rendering the image 422 in a given position that the object maintains when one or more laws of physics are disregarded in the simulation of movement of the object to accommodate the user's request.

In an example, as shown in FIG. 4B, the computing device may be configured to provide in the 3D image viewer 420 an advertisement or similar supplemental information space 430 (hereafter “advertisement space”. In an example, the computing device may be configured to provide in the advertisement space 430, advertising or other supplemental information 432 (hereafter “advertising information) associated with the object depicted in the image 422 (e.g., the object advertised in corresponding 2D advertisement 410A). The computing device may be configured to vary the advertising information 432 based on a view and/or position of the object in the 3D image viewer 420.

FIG. 4C illustrates the example 3D image viewer 420 with interactive options, in accordance with an embodiment. The computing device may be configured to provide interactive options 434 to a user. As an example, the object advertised may be depicted in the image 422 in a given material and the interactive options 434 may allow the user to click on an icon 436 to view the object depicted in a different material, for example. The computing device may be configured to simulate the object given a change in the material of the object to determine a corresponding rest position. This example is used for illustration only. Other interacting forms are possible.

FIG. 4D illustrates an object with multiple components in the example 3D image viewer 420 with interactive options, in accordance with an embodiment. FIG. 4D illustrates a given image of an object composed of multiple components such as component 438 and component 440 made of respective materials. In an example, the computing device may be configured to receive a request to change a material of one or both components 438 and 440 by way of the interactive options 434. The computing device may be configured accordingly to simulate movement of the object, by way of the physics-based simulation, to determine a rest position corresponding to a change in respective materials of one or both components 438 and 440.

In some examples, the object may be made of a soft material (e.g., the object is a shirt). The computing device may be configured to render the image depicting the object in a rest position on a surface of a given shape (e.g., a mannequin).

FIG. 4E illustrates an example display of a shirt 442 on a mannequin 444 in the example 3D image viewer, in accordance with an embodiment. This shirt on a mannequin example is for illustration only. Other examples of objects made of non-rigid materials are possible. In the example illustrated in FIG. 4E, the computing device may be configured to determine a rest position of the shirt on the mannequin, by way of the physics-based simulation that uses physics principles of soft body dynamics to simulate an effect of the one or more forces applied to the object. The computing device may be configured to determine a respective shape of the shirt that is topologically compliant with the mannequin, for example. The shirt 442 may, thus, be displayed in the 3D image viewer 420 in a rest position on the mannequin 444 that simulates how a physical shirt would look as displayed on a real mannequin in a store, for example. The physics-based simulation may take into account physical properties of the mannequin 444 such as rigidity/flexibility. For example, the mannequin 444 may be made of a rigid material (e.g., wood) or may be made of a wire frame that is flexible. Determining the rest position of the shirt 442 on the mannequin 444 in this example, may take into account effect of gravity and weight of the shirt 442 on a shape of the mannequin 444 made of the flexible wire frame, for example.

In an example, the computing device may be configured to continuously simulate the object subjected to a force varying with time. For example, in FIG. 4E, the computing device may be configured to simulate an effect of a stream of wind/air flowing from a given side toward the shirt 442 resting on the mannequin 444. The computing device may be configured to generate a corresponding animated display of the shirt 442 in the 3D image viewer 420, based on simulating the shirt 442 subjected to a force varying with time and representing the air stream. In an example, the computing device further may be configured to provide the corresponding animated display for the default view in the 3D image viewer 420.

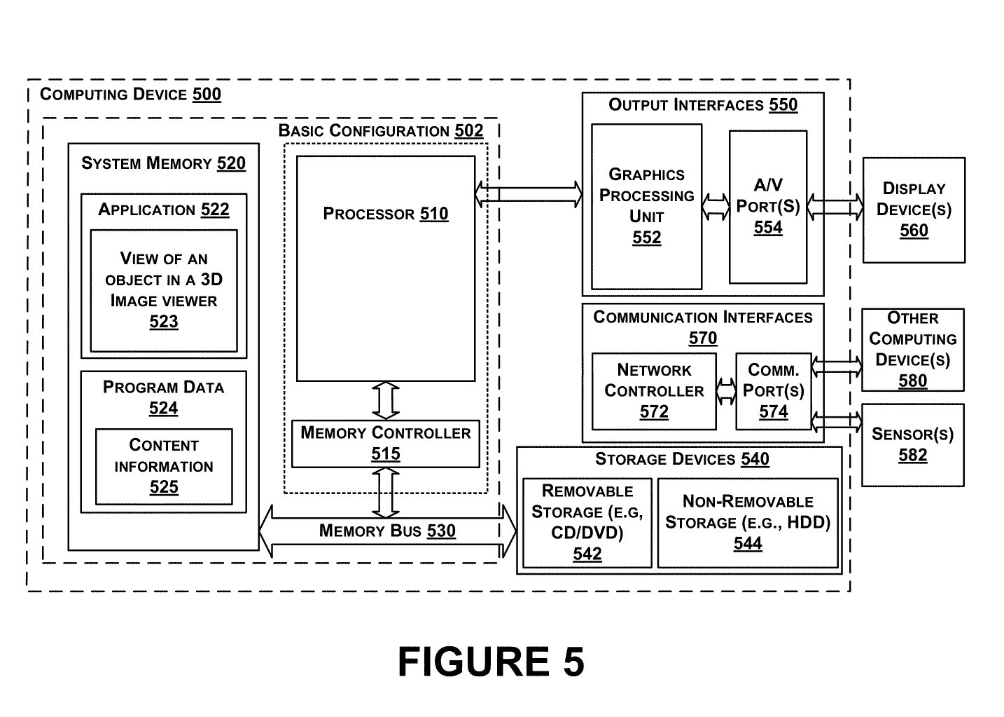

FIG. 5 is a functional block diagram illustrating an example computing device used in a computing system that is arranged in accordance with at least some embodiments described herein. The computing device may be a personal computer, mobile device, cellular phone, touch-sensitive wristwatch, tablet computer, video game system, or global positioning system, and may be implemented to provide a system for image marking and three-dimensional (3D) image generation system as described in FIGS. 1-4. The computing device 500 may, for example, be used to implement the method 300 illustrated in FIG. 3.

In a basic configuration 502, computing device 500 may typically include one or more processors 510 and system memory 520. A memory bus 530 can be used for communicating between the processor 510 and the system memory 520. Depending on the desired configuration, processor 510 can be of any type including but not limited to a microprocessor (μP), a microcontroller (μC), a digital signal processor (DSP), or any combination thereof. A memory controller 515 can also be used with the processor 510, or in some implementations, the memory controller 515 can be an internal part of the processor 510.

Depending on the desired configuration, the system memory 520 can be of any type including but not limited to volatile memory (such as RAM), non-volatile memory (such as ROM, flash memory, etc.) or any combination thereof. System memory 520 may include one or more applications 522, and program data 524. Application 522 may include view of an object in a 3D image viewer algorithm 523. Program data 524 may include content information 525 that could be directed to any number of types of data. In some example embodiments, application 522 can be arranged to operate with program data 524 on an operating system.

Computing device 500 can have additional features or functionality, and additional interfaces to facilitate communications between the basic configuration 502 and any devices and interfaces. For example, data storage devices 540 can be provided including removable storage devices 542, non-removable storage devices 544, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Computer storage media can include volatile and nonvolatile, non-transitory, removable and non-removable media implemented in any method or technology for storage of information, such as computer readable instructions, data structures, program modules, or other data.

System memory 520 and storage devices 540 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 500. Any such computer storage media can be part of the computing device 500.

The computing device 500 can also include output interfaces 550 that may include a graphics processing unit 552, which can be configured to communicate to various external devices such as display devices 560 or speakers via one or more A/V ports 554 or a communication interface 570. The communication interface 570 may include a network controller 572, which can be arranged to facilitate communications with one or more other computing devices 580 and one or more sensors 582 over a network communication via one or more communication ports 574. The one or more sensors 582 are shown external to the computing device 500, but may also be internal to the device. The communication connection is one example of a communication media. Communication media may be embodied by computer readable instructions, data structures, program modules, or other data in a modulated data signal, such as a carrier wave or other transport mechanism, and includes any information delivery media. A modulated data signal can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media.

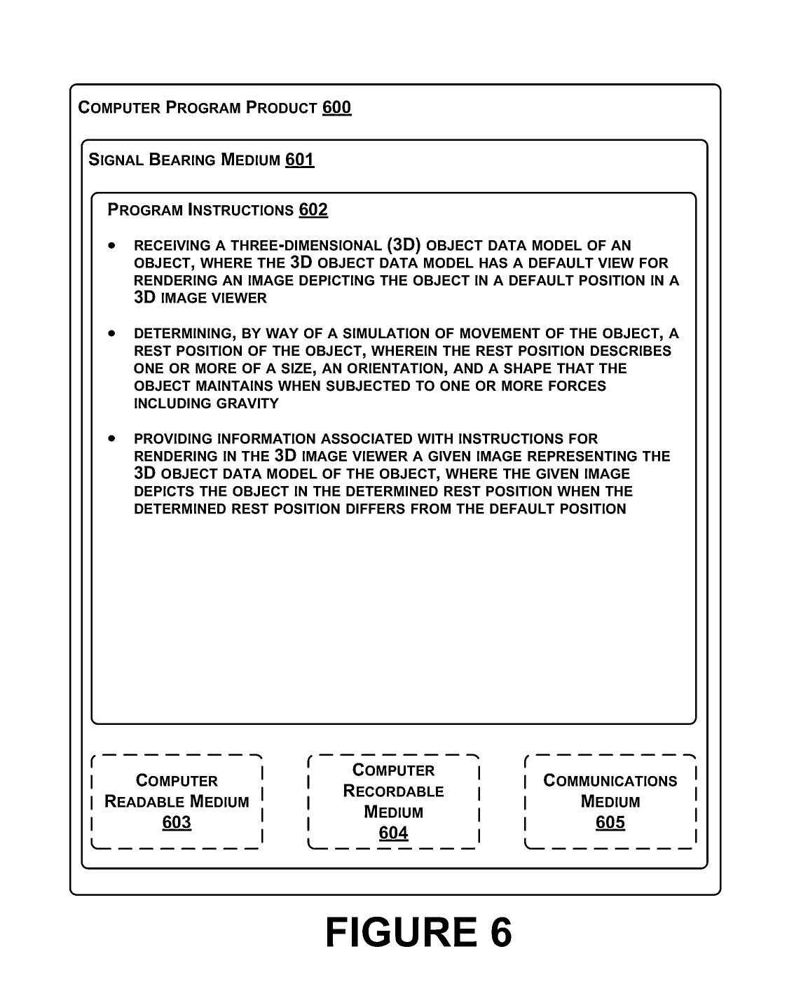

In some embodiments, the disclosed methods may be implemented as computer program instructions encoded on a non-transitory computer-readable storage media in a machine-readable format, or on other non-transitory media or articles of manufacture. FIG. 6 is a schematic illustrating a conceptual partial view of an example computer program product that includes a computer program for executing a computer process on a computing device, arranged according to at least some embodiments presented herein.

In one embodiment, the example computer program product 600 is provided using a signal bearing medium 601. The signal bearing medium 601 may include one or more programming instructions 602 that, when executed by one or more processors may provide functionality or portions of the functionality described above with respect to FIGS. 1-5. In some examples, the signal bearing medium 601 may encompass a computer-readable medium 603, such as, but not limited to, a hard disk drive, a Compact Disc (CD), a Digital Video Disk (DVD), a digital tape, memory, etc. In some implementations, the signal bearing medium 601 may encompass a computer recordable medium 604, such as, but not limited to, memory, read/write (R/W) CDs, R/W DVDs, etc. In some implementations, the signal bearing medium 601 may encompass a communications medium 605, such as, but not limited to, a digital and/or an analog communication medium (e.g., a fiber optic cable, a waveguide, a wired communications link, a wireless communication link, etc.). Thus, for example, the signal bearing medium 601 may be conveyed by a wireless form of the communications medium 605 (e.g., a wireless communications medium conforming to the IEEE 802.11 standard or other transmission protocol).

The one or more programming instructions 602 may be, for example, computer executable and/or logic implemented instructions. In some examples, a computing device such as the computing device 500 of FIG. 5 may be configured to provide various operations, functions, or actions in response to the programming instructions 602 conveyed to the computing device 500 by one or more of the computer readable medium 603, the computer recordable medium 604, and/or the communications medium 605.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

1. A method, comprising:
receiving, at a computing device, a three-dimensional (3D) object data model of an object, wherein the 3D object data model has a default view for rendering an image depicting the object in a default position;
determining, by way of a simulation of movement of the object, a rest position of the object, wherein the rest position describes one or more of a size, an orientation, and a shape that the object maintains when subjected to one or more forces including gravity;
determining, based on the one or more of the size, the orientation, and the shape that the object maintains when subjected to the one or more forces including gravity, that the rest position of the object differs from the default position;
based on determining that the rest position of the object differs from the default position, determining, from among the rest position of the object and the default position, which of the rest position of the object or the default position to render in a 3D imager viewer; and
in response, providing information associated with instructions for rendering in the 3D image viewer a given image representing the 3D object data model of the object in the determined position.

2. The method of claim 1, further comprising receiving, at the computing device, a request to view the object in the 3D image viewer.

3. The method of claim 2, further comprising:
generating a display of an advertisement; and
receiving the request to view the object in the 3D image viewer by way of a selection of the advertisement.

4. The method of claim 1, further comprising:
receiving a given request to change a view of the object in the 3D image viewer;
determining a respective rest position corresponding to the changed view; and
generating a display, in the 3D image viewer, of the object in the respective rest position.

5. The method of claim 1, wherein determining the rest position comprises determining the rest position of the object on a given surface based on one or more physical properties of the given surface.

6. The method of claim 1, further comprising:
continuously simulating the object subjected to a force varying with time;
generating a corresponding animated display of the object based on simulating the object; and
providing the corresponding animated display for the default view.

7. The method of claim 1, further comprising determining the rest position of the object on a surface of a given shape, by way of the simulation of movement that uses one or more physics principles of soft body dynamics to simulate an effect of the one or more forces on the object, wherein determining the rest position comprises determining a respective shape of the object that is topologically compliant with the given shape of the surface.

8. The method of claim 1, wherein the 3D object data model is characterized based on one or more parameters defining rendering features of the image, wherein the one or more parameters include a material parameter characterizing a material of the object, and wherein determining the rest position of the object is based on the material of the object.

9. The method of claim 1, wherein the object comprises multiple components, wherein a respective material is associated with each respective component of the multiple components, and wherein determining the rest position by way of the simulation of movement of the object is based on the respective material of the respective component.

10. The method of claim 9, further comprising:
receiving a given request for a change of a given material associated with a given component of the multiple components;
determining a given rest position of the object based on the change of the given material; and
generating a display of the object in the given rest position.

11. The method of claim 9, wherein determining the rest position of the object comprises determining a center of gravity of the object based on the respective material of the multiple components.

12. The method of claim 1, further comprising rendering the image to depict the object in the determined rest position in the 3D image viewer.

13. The method of claim 1, further comprising providing a webpage, wherein the webpage includes executable instructions identifying the 3D image viewer embedded within the webpage.

14. The method of claim 13, further comprising:
receiving, at the computing device, a request to view the object in the 3D image viewer; and
providing, based on the request, the 3D image viewer in a pop-up window.

15. The method of claim 1, wherein the object includes a component with a predetermined upright orientation, and the method further comprising modifying the determined rest position to render the image such that the component is depicted in the predetermined upright orientation.

16. A non-transitory computer readable medium having stored thereon instructions executable by a computing device to cause the computing device to perform functions comprising:
receiving a three-dimensional (3D) object data model of an object, wherein the 3D object data model has a default view for rendering an image depicting the object in a default position;
determining, by way of a simulation of movement of the object, a rest position of the object, wherein the rest position describes one or more of a size, an orientation, and a shape that the object maintains when subjected to one or more forces including gravity;
determining, based on the one or more of a size, an orientation, and a shape that the object maintains when subjected to one or more forces including gravity, that the rest position of the object differs from the default position;
based on determining that the rest position of the object differs from the default position, determining, from among the rest position of the object and the default position, which of the rest position of the object or the default position to render in a 3D image viewer; and
in response, providing information associated with instructions for rendering in the 3D image viewer a given image representing the 3D object data model of the object in the determined position.

17. The non-transitory computer readable medium of claim 16, further comprising instructions executable by the computing device to cause the computing device to perform functions comprising:
receiving information associated with a preferred orientation of the object;
determining a respective rest position corresponding to the preferred orientation; and
rendering the image to depict the object in the determined respective rest position in the 3D image viewer.

18. A system, comprising:
a computing device; and
a memory, the memory storing instructions executable by the computing device to cause the computing device to:
receiving a three-dimensional (3D) object data model of an object, wherein the 3D object data model has a default view for rendering an image depicting the object in a default position;
determining, by way of a simulation of movement of the object, a rest position of the object, wherein the rest position describes one or more of a size, an orientation, and a shape that the object maintains when subjected to one or more forces including gravity;
determining, based on the one or more of a size, an orientation, and a shape that the object maintains when subjected to one or more forces including gravity, that the rest position of the object differs from the default position;
based on determining that the rest position of the object differs from the default position, determining, from among the rest position of the object and the default position, which of the rest position of the object or the default position to render in a 3D image viewer; and
in response, providing information associated with instructions for rendering in the 3D image viewer a given image representing the 3D object data model of the object in the determined position.

19. The system of claim 18, wherein the instructions are further executable by the computing device to cause the computing device to:
generate a display of an advertisement;
provide a user-selectable space in the advertisement; and
receive a request to view the object in the 3D image viewer in response to a selection of the user-selectable space.

20. The system of claim 18, wherein the instructions are further executable by the computing device to cause the computing device to:
receive feedback responsive to the given position depicted in the 3D image viewer, wherein the feedback is indicative of acceptance or rejection of the determined given position; and
modify the given position to generate a view for rendering the image in a respective position that the object maintains when one or more laws of physics are disregarded in the simulation of movement of the object.
